(19) United States
(12) Patent Application Publication
(10) Pub. No.: US 2023/0051457 A1
(43) Pub. Date: Feb. 16, 2023

(54) INTELLIGENT VALIDATION OF NETWORK-BASED SERVICES VIA A LEARNING PROXY

(71) Applicant: Microsoft Technology Licensing, LLC, Redmond, WA (US)

(72) Inventors: Piyush GUPTA, Sammamish, WA (US); Ritchie Nicholas HUGHES, Salt Lake City, UT (US); Weili Zhong MCCLENAHAN, Seattle, WA (US)

(21) Appl. No.: 17/402,454

(22) Filed: Aug. 13, 2021

(51) Int. Cl. G06N 3/08

(52) U.S. Cl. CPC G06N 3/08

(57) ABSTRACT

Techniques described herein are directed to the intelligent validation of network-based services via a proxy. The proxy is communicatively coupled to a first network-based service and a second network-based service. The proxy is utilized to validate the functionality of the first network-based service with respect to the second network-based service. The proxy initially operates in a first mode in which the proxy monitors and analyzes the transactions between the first and second network-based services and learns the behavior of the second network-based service. The proxy then operates in a second mode in which the proxy simulates the learned behavior of the second network-based service. When operating in the second mode, requests initiated by the first network-based service and intended for the second network-based service are provided to the proxy, and the proxy generates a response to the request in accordance with the learned behavior of the second network-based service.

### BACKGROUND

Distributed systems have multiple components, such as a plurality of microservices, that work in cooperation to implement a larger, overall application. Typically, a developer works on a small subset of such microservices. These microservices may have dependencies on other microservices that are maintained by other developers. When testing a microservice, a developer may create simulated microservices on which the microservice depends in an attempt to verify the functionality therebetween. Given that a microservice can have hundreds of dependent microservices, microservice validation becomes a tedious task. Moreover, such simulated microservices have limited functionality and do not provide a comprehensive validation approach, thereby increasing the chance of missing bugs in the microservice.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are directed to the intelligent validation of network-based services via a proxy. For example, the proxy is communicatively coupled to a first network-based service and a second network-based service. The proxy is utilized to validate the functionality of the first network-based service with respect to the second network-based service. The proxy initially operates in a first mode in which the proxy monitors and analyzes the transactions between the first and second network-based services and learns the behavior of the second network-based service based on the analysis. After learning the behavior, the proxy operates in a second mode in which the proxy simulates the behavior of the second network-based service. When operating in the second mode, requests initiated by the first network-based service and intended for the second network-based service are received by the proxy and are not provided to the second network-based service. The proxy generates a response to the request in accordance with the learned behavior of the second network-based service.

Further features and advantages of the disclosed embodiments, as well as the structure and operation of various embodiments, are described in detail below with reference to the accompanying drawings. It is noted that the disclosed embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system configured to simulate and validate network-based services in accordance with an example embodiment.

FIG. 2 depicts a flowchart of an example method for simulating a network-based service in accordance with an example embodiment.

FIG. 3 is a block diagram of a system for simulating a network-based service in accordance with an example embodiment.

FIG. 4 depicts a flowchart of an example method for switching from a first mode of a proxy to a second mode of the proxy in accordance with an example embodiment.

FIG. 5 depicts a flowchart of an example method for injecting faults into responses generated by a network-based service model in accordance with an example embodiment.

FIG. 6 is a block diagram of system for injecting faults into responses generated by a network-based service model in accordance with an example embodiment.

FIG. 7 is a block diagram of an exemplary user device in which embodiments may be implemented.

FIG. 8 is a block diagram of an example processor-based computer system that may be used to implement various embodiments.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

The embodiments described herein are directed to the intelligent validation of network-based services via a proxy. For example, the proxy is communicatively coupled to a first network-based service and a second network-based service. The proxy is utilized to validate the functionality of the first network-based service with respect to the second network-based service. The proxy may operate in a first mode in which the proxy monitors and analyzes the transactions between the first and second network-based services and learns the behavior of the second network-based service based on the analysis. After learning the behavior, the proxy operates in a second mode in which the proxy simulates the behavior of the second network-based service. When operating in the second mode, requests initiated by the first network-based service and intended for the second network-based service are received by the proxy and are not provided to the second network-based service. The proxy generates a response to the request in accordance with the learned behavior of the second network-based service.

The techniques described herein advantageously enable highly-functional, simulated network-based services to be easily generated and utilized to test the functionality and performance of a network-based service being developed. The simulated network-based services described herein provide a more accurate representation of the network-based service being mimicked, thereby enabling greater test scenarios to be validated. By doing so, a greater number of bugs in the network-based service being tested may be found and resolved, thereby resulting in a stable and reliable network-based service. This advantageously limits the system-wide impact of an unreliable network-based service failing. For instance, if one network-based service fails, any network-based service that depends thereon will also likely fail. Such cascading failures can result in increased latency with respect to transactions and/or result in certain transactions failing or being dropped.

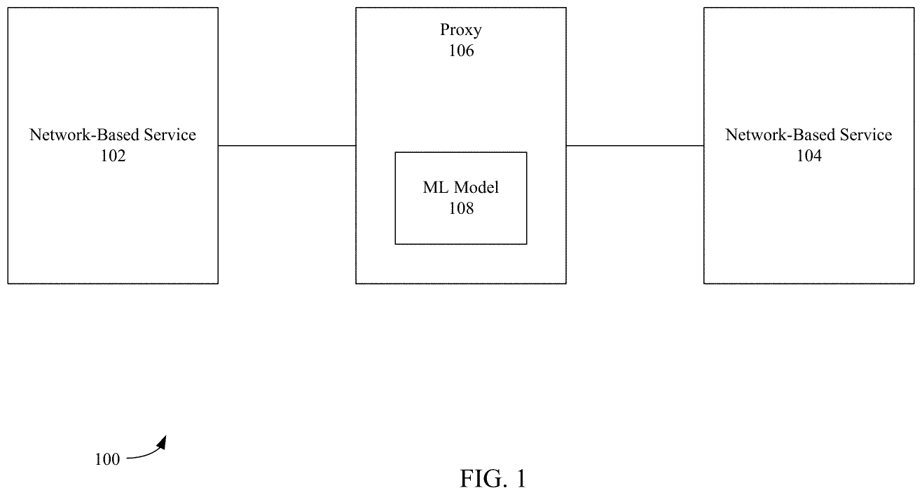

Embodiments may be implemented in a variety of systems. For instance, FIG. 1 is a block diagram of a system 100 configured to simulate and validate network-based services in accordance with an example embodiment. As shown in FIG. 1, system 100 comprises a first network-based service 102, a second network-based service 104, and a proxy 106. System 100 is described in detail as follows. Each of first network-based service 102, second network-based service 104, and proxy 106 may be communicatively coupled via one or more networks. In accordance with an embodiment, each of network-based service 102, proxy 106, and network-based service 104 may execute on a separate computing device, e.g., a node within a cloud services platform. Examples of network(s) include, but are not limited to, include, local area networks (LANs), wide area networks (WANs), enterprise networks, the Internet, etc., and may include one or more of wired and/or wireless portions.

Each of network-based services 102 and 104 may comprise a web application, a web service, a web application programming interface (API), or a microservice. Microservices are small, independently versioned and scalable, modular customer-focused services (computer programs/applications) that communicate with each other over standard protocols (e.g., HTTP, SOAP, etc.) with well-defined interfaces (e.g., application programing interfaces (APIs)). Each microservice may implement a set of focused and distinct features or functions for a larger, overall application. Microservices may be written in any programming language and may use any framework.

One or more of network-based services 102 and 104 may have a dependency with respect to another network-based service. For instance, first network-based service 102 may be dependent on second network-based service 104. For examples, first network-based service 102 may require responses and/or data from second network-based service 104.

Proxy 106 may be an application or service that is configured to generate a machine learning model 108 that is configured to simulate the behavior of a network-based service on which first network-based service 102 has a dependency. For instance, machine learning model 108 may be configured to simulate the behavior of second network-based service 104. By doing so, first network-based service 102 may be tested and validated utilizing machine learning model 108 rather than utilizing second network-based service 106.

To generate machine learning model 108, proxy 106 operates in a learning mode, where proxy 106 is configured to act as a pass-through that receives requests provided by first network based-service 102, provides the requests to second network-based service 104, and receives responses from second network-based service 104 for such requests, and provides such responses to first network-based service 102. Proxy 106 is configured to determine and/or store data and characteristics associated with such requests and responses. For instance, the data and characteristics may comprise data (or a payload) included in the responses, information stored in a header of such requests and responses (e.g., sequence numbers, timestamps, status codes, etc.), a time at which requests are provided by first network-based service 102, a time at which responses are provided by second network-based service 104, the latency between a given request-response pair, etc.

In accordance with an embodiment, proxy 106 utilizes a deep neural network-based machine learning algorithm to generate machine learning model 108. However, it is noted that the embodiments described herein are not so limited and that other machine learning algorithms may be utilized, including, but not limited to, supervised machine learning algorithms and unsupervised machine learning algorithms.

In accordance with an embodiment, first network-based service 102, second network-based service 104, and proxy 106 are configured to transmit requests and/or responses in accordance with a hypertext transfer protocol (HTTP). In accordance with such an embodiment, the status codes may comprise informational responses (status codes in the range of 100-199), successful response (status codes in the range of 200-299), redirect responses (status codes in the range of 300-399), client error responses (status codes in the range of 400-499), and/or server error responses (status codes in the range of 500-599).

Proxy 106 is configured to analyze such data and characteristics of requests and responses to learn how second network-based service 104 behaves. The learning aspect applies not only to requests and responses, but also to other characteristics of second network-based service 104, such as performance and failure. Proxy 106 is configured to provide such data and characteristics as training data to a machine learning algorithm. The machine learning algorithm is configured to generate machine learning model 108 based on the training data. Machine learning model 108 simulates the behavior of second network-based service 106.

After machine learning model 108 is generated, proxy 106 switches to simulate (or “mock”) mode, where proxy 106 simulates the behavior of second network-based service 104. For instance, proxy 106 may generate (or simulate) responses to requests provided by first network-based service 106. In this mode, proxy 106 does not provide the requests provided by first network-based service 102 to second network-based service 104. Instead, proxy 106 provides such requests to machine learning model 108. A developer may validate the functionality of first network-based service 102 based on the responses generated and received by machine learning model 108 of proxy 106.

It is noted that while the embodiments described herein disclose that proxy 106 is communicatively coupled to network-based service 102 via a network, the embodiments described herein are not so limited. For instance, proxy 106 may be executed locally on the same computing device on which network-based service 102 executes. A developer may either execute proxy 106 locally or utilize proxy 106 as a service, for example, executing in a cloud services platform, when validating network-based service 102.

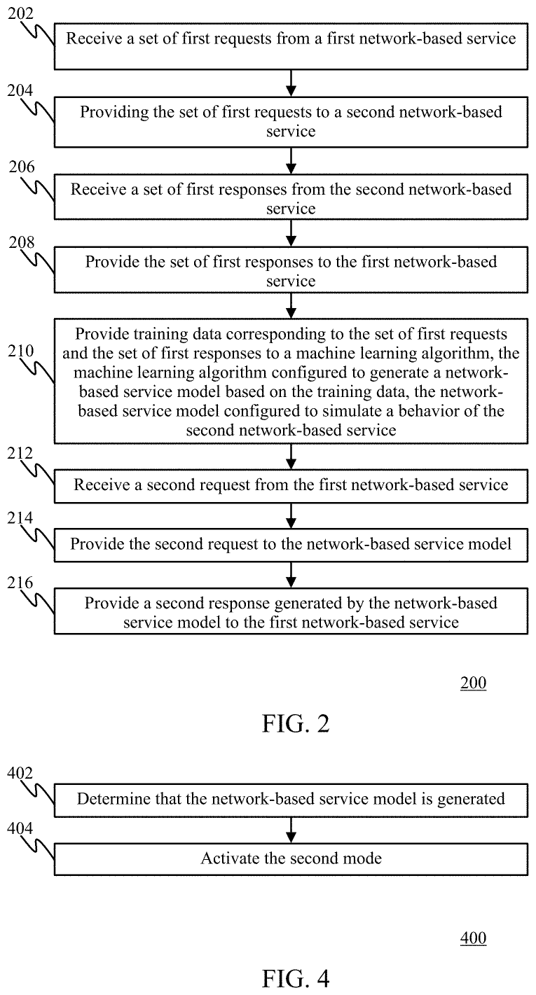

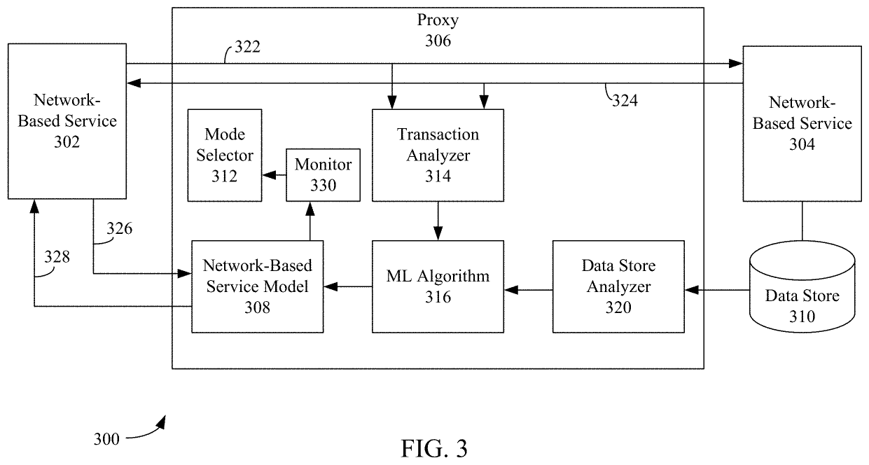

Accordingly, network-based services may be simulated and validated in various ways. For example, FIG. 2 depicts a flowchart 200 of an example method for simulating a network-based service in accordance with an example embodiment. In an embodiment, flowchart 200 may be implemented by a system 300, as shown in FIG. 3. FIG. 3 is a block diagram of a system 300 for simulating a network-based service in accordance with an example embodiment. As shown in FIG. 3, system 300 comprises a first network-based service 302, a second network-based service 304, a proxy 306, and a data store 310. First network-based service 302, second network-based service 304, and proxy 306 are examples of first network-based service 102, second network-based service 104, and proxy 106, as respectively described above with reference to FIG. 1. Data store 310 may comprise a database, a storage device, or memory device to which network-based service 304 is communicatively coupled. Second network-based service 304 may be configured to read and/or write data to data store 310, for example, responsive to receiving requests received from first network-based service 302. Data store 310 may be communicatively coupled to network-based service 304 and/or proxy 306, for example, via one or more networks (e.g., network(s) 106, as shown in FIG. 1). As further shown in FIG. 3, proxy 306 may comprise a mode selector 312, a transaction analyzer 314, a machine learning algorithm 316, a network-based service model 308, a data store analyzer 320, and a monitor 330. Network-based service model 308 is an example of machine learning model 108, as described above with reference to FIG. 1. Mode selector 312 is configured to place proxy 306 in one of two modes (e.g., a learning mode and a simulate mode). Before network-based service model 308 is generated, mode selector 312 may cause proxy 306 to operate in accordance with a first mode (e.g., the learning mode). Other structural and operational embodiments will be apparent to persons skilled in the relevant art(s) based on the discussion regarding flowchart 200 and system 300 of FIG. 3. It is noted that steps 202, 204, 206, 208, and 210 of FIG. 2 may be performed when proxy is in a first mode (e.g., the learning mode) and that steps 212, 214, and 216 of FIG. 2 may be performed when proxy is in a second mode (e.g., the simulate mode). Additional details regarding mode selection are described below with reference to flowchart 400 of FIG. 4.

As shown in FIG. 2, the method of flowchart 200 begins at step 202. At step 202, a set of first requests are received from a first network-based service. For example, with reference to FIG. 3, requests generated by first network-based service 302 (shown as requests 322) are received by proxy 306. Each of requests 322 may be received at different times (e.g., over the course of many hours, days, weeks, etc.).

At step 204, the set of first requests are provided to a second network-based service. For example, with reference to FIG. 3, proxy 306 provides requests 322 to second network-based service 304. When operating in the first mode, proxy 306 acts as a pass-through where requests 322 received from first network-based service 302 are passed through to second network-based service 304.

In accordance with one or more embodiments, each of the first network-based service and the second network-based service comprises at least one of a web service, a web API, or a microservice. For example, with reference to FIG. 3, each of first network-based service 302 and second network-based service 306 comprises at least one of a web service, a web API, or a microservice.

At step 206, a set of first responses from the second network-based service is received. For example, with reference to FIG. 3, responses generated by second network-based service 304 (shown as responses 324) are received by proxy 306.

At step 208, the set of first responses are provided to the first network-based service. For example, with reference to FIG. 3, proxy 306 provides responses 324 to first network-based service 302. When operating in the first mode, proxy 204 acts as a pass-through where responses 324 received from second network-based service 306 are passed through to first network-based service 302. Each of responses 324 may be received at different times (e.g., over the course of many hours, days, weeks, etc.).

At step 210, training data corresponding to the set of first requests and the set of first responses is provided to a machine learning algorithm. The machine learning algorithm is configured to generate a network-based service model based on the training data. The network-based service model is configured to simulate a behavior of the second network-based service. For example, with reference to FIG. 3, each of requests 322 and each of responses 324 are provided to transaction analyzer 314. Transaction analyzer 314 is configured to analyze transactions between first network-based service 302 and second network-based service 304. For instance, transaction analyzer 314 may determine data and/or and characteristics associated with requests 322 and responses 324. Examples of data and/or characteristics includes, but are not limited to, data (or a payload) included in responses 322, information stored in a header of requests 322 and/or responses 324 (e.g., sequence numbers, timestamps, status codes, etc.), a time at which requests 322 are provided by first network-based service 302, a time at which responses 324 are provided by second network-based service 304, the latency between a give request-response pair, etc. Transaction analyzer 314 is configured to provide such data and characteristics as training data to machine learning algorithm 316. Machine learning algorithm 316 is configured to generate network-based service model 308, which is configured to simulate the behavior of second network-based service 304. For instance, network-based service model 308 is configured to generate responses responsive to receiving requests from network-based service 302 in a similar manner as second network-based service 304.

In accordance with one or more embodiments, the machine learning algorithm is a deep neural network (DNN)-based machine learning algorithm. For example, with reference to FIG. 3, machine learning algorithm 316 is a deep neural network-based machine learning algorithm.

A DNN is an artificial neural network (ANN) with multiple layers between the input and output layers. There are different types of DNNs that include components such as neurons, synapses, weights, biases, and functions. These components function similar to those of human brains and can be trained similarly to other machine learning (ML) algorithms. A DNN generally consists of a sequence of layers of different types (e.g., a convolution layer, a rectified linear unit (ReLU) layer, a fully connected layer, pooling layers, etc.). In accordance with embodiments described herein, a DNN may be trained to process data and/or characteristics of requests 322 generated by first network-based service 302 and generated by responses 324 generated by second network-based service 304.

The DNN may be trained across multiple epochs. In each epoch, the DNN trains over all of the training data in a training dataset in multiple steps. In each step, the DNN first makes a prediction for a subset of the training data, which is referred herein as a “minibatch” or a “batch.” This step is commonly referred to as a “forward pass.”

To make a prediction, input data from a minibatch is fed to the first layer of the DNN, which is commonly referred to as an “input layer.” Each layer of the DNN then computes a function over its inputs, often using learned parameters, or “weights,” to produce an input for the next layer. The output of the last layer, commonly referred to as the “output layer,” is the network-based service 304 response predicted by network-based service model 308. Based on the response predicted by the DNN and training data inputted to machine learning algorithm 316, the output layer computes a “loss,” or error function.

In a “backward pass” of the DNN, each layer of the DNN computes the error for the previous layer and the gradients, or updates, to the weights of the layer that move the DNN's prediction toward the desired output. The result of training a DNN is a set of weights, or “kernels,” that represent a transform function that can be applied to requests provided by first network-based service 302 with the result being predicted and generated second network-based service 304 responses to the requests. Once the transform function is determined, the machine learning model (i.e., network-based service model 308) may be saved, transferred to, and executed on any number of different computing devices. This enables the other devices to implement the machine learning model without having to perform the foregoing training process.

In accordance with one or more embodiments, second training data, corresponding to transactions performed by the second network-based service with respect to a data store communicatively coupled to the second network-based service, is provided to the machine learning algorithm. For example, with reference to FIG. 3, transactions performed with respect to data store 310 may be analyzed, and data and/or characteristics associated with such transactions may be provided as additional training data to machine learning algorithm 316. For instance, data store analyzer 320 may be configured to monitor read and/or write transactions performed by second network-based service 304 with respect to data store 310. Examples of transactions include, but are not limited, transactions that create records in data store 310, read data from data store 310, write data to data store 310, or delete data from data store 310. Data store analyzer 320 may also monitor the length of time it takes to complete such transactions. In an example, second network-based service 304 may receive a request from first network-based service 302 to create a record in a database maintained by data store 310. After the record is created, second network-based service 304 may provide a particular type of response to first network-based service 302 indicating as such. Data store analyzer 320 may monitor data store 310 to determine the length of time it takes for the record to be created. Data store analyzer 320 may provide such information as training data to machine learning algorithm 316. Machine learning algorithm 316 may train network-based service model 308 to generate the particular type of response in accordance with the determined length of time. For instance, if it takes a certain write transaction 10 milliseconds to complete from receiving a request to write data from first network-based service 302, network-based service model 308 may ensure that the corresponding response is provided to first network-based service 302 at least 10 milliseconds from receiving the request. It is noted that in embodiments data store analyzer 320 may be incorporated via network-based service 304 and/or data store 310. In accordance with such embodiments, the data and/or characteristics determined by data store analyzer 320 may be provided to proxy 306, which proxy 306 provides to machine learning algorithm 316 as training data.

At step 212, a second request is received from the first network-based service. For example, with reference to FIG. 1, proxy 306 receives a second request 326 from first network-based service 302.

At step 214, the second request is provided to the network-based service model. For example, with reference to FIG. 1, second request 326 is provided to network-based service model 308 and is not provided to second network-based service 304, as proxy 306 is now operating in the second mode (i.e., the simulate mode).

At step 216, a second response generated by the network-based service model is provided to the first network-based service. For example, with reference to FIG. 3, network-based service model 210 generates a second response 328 responsive to receiving second request 326. Proxy 306 provides second response 328 to first network-based service 302.

FIG. 4 depicts a flowchart 400 of an example method for switching from a first mode of the proxy to a second mode of the proxy in accordance with an example embodiment. In an embodiment, flowchart 400 may be implemented by system 300, as shown in FIG. 3. Accordingly, flowchart 400 will be described with continued reference to system 300. Other structural and operational embodiments will be apparent to persons skilled in the relevant art(s) based on the discussion regarding flowchart 400 and system 300 of FIG. 3.

As shown in FIG. 4, the method of flowchart 400 begins at step 402. At step 402, a determination is made that the network-based service model is generated. For example, with reference to FIG. 3, monitor 330 is configured to monitor the generation of network-based service model 308. After determining that network-based service model 308 has been generated, monitor 330 may provide a notification to mode selector 312 indicating that network-based service model 308 has been generated.

At step 404, in response to determining that the network-based service model is generated, the second mode is activated. For example, with reference to FIG. 4, mode selector 312 activates the second mode (e.g., the simulate mode) in response to receiving the notification from monitor 330.

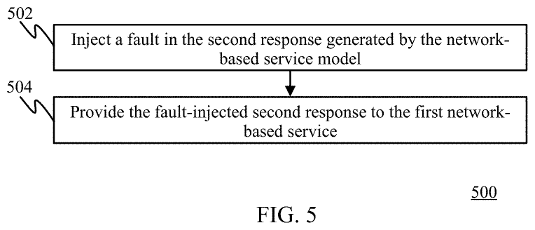

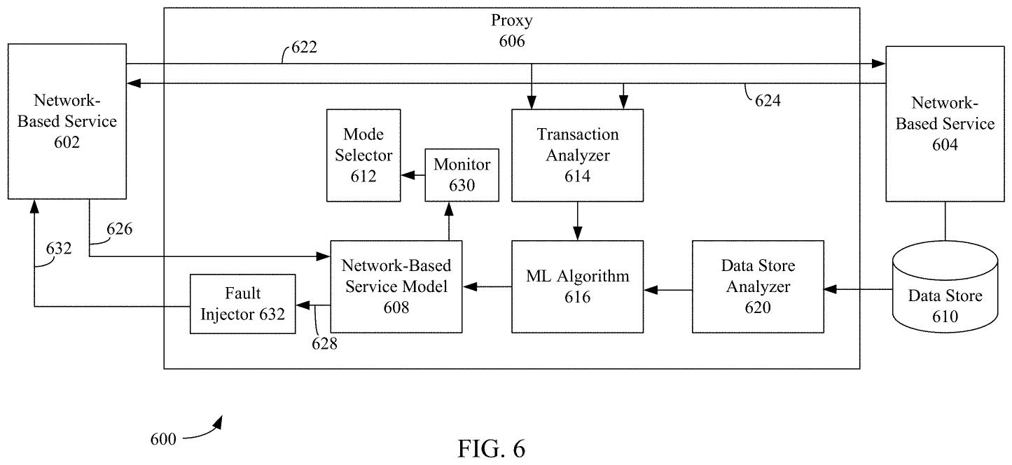

In accordance with one or more embodiments, faults may be injected into responses that are generated by network-based service model 308. For instance, FIG. 5 depicts a flowchart 500 of an example method for injecting faults into responses generated by a network-based service model in accordance with an example embodiment. In an embodiment, flowchart 500 may be implemented by a system 600, as shown in FIG. 6. FIG. 6 is a block diagram of system 600 for injecting faults into responses generated by a network-based service model in accordance with an example embodiment. As shown in FIG. 6, system 600 comprises a first network-based service 602, a second network-based service 604, a proxy 606, and a data store 610. First network-based service 602, second network-based service 604, proxy 606, and data store 610 are examples of first network-based service 302, second network-based service 304, proxy 306, and data store 610, as respectively described above with reference to FIG. 1. As further shown in FIG. 6, proxy 606 may comprise a mode selector 612, a transaction analyzer 614, a machine learning algorithm 616, a network-based service model 608, a data store analyzer 620, a monitor 630, and a fault injector 632. Mode selector 612, transaction analyzer 614, machine learning algorithm 616, network-based service model 608, and data store analyzer 620 are examples of mode selector 312, transaction analyzer 314, machine learning algorithm 316, network-based service model 308, and data store analyzer 320, as respectively described above with reference to FIG. 3. Other structural and operational embodiments will be apparent to persons skilled in the relevant art(s) based on the discussion regarding flowchart 500 and system 600 of FIG. 6.

As shown in FIG. 5 the method of flowchart 500 begins at step 502. At step 502, a fault is injected in the second response generated by the network-based service model. For example, with reference to FIG. 6, fault injector 632 is configured to inject a fault in a second response 628 generated by network-based service model 608. Second response 628 is an example of second response 328, as described above with reference to FIG. 3.

In accordance with one or more embodiments, injecting the fault comprises at least one of modifying a sequence number specified by the second request, modifying a timestamp specified by the second request, modifying a status code of the second request, or injecting a delay at which the second request is provided to the first network-based service. For example, with reference to FIG. 6, fault injector 632 may be configured to modify data included in second request 628. The data may be included in a header of second request 628 or the payload data of second request 628. Examples of data that may be modified include, but are not limited to, a sequence number specified by second request 628, a timestamp specified by second request 628, a status code of second request 628, etc. In an example, fault injector 632 may change a successful status code to an error status code. This advantageously enables failure scenarios to be tested for first network-based service 602. Fault injector 632 may further inject a delay at which second request 628 is provided to first network-based service 602. For instance, fault injector 632 may buffer second request 628 for a particular time period (e.g., either a predetermined time period or a randomly-determined time period) and provide second request 628 upon expiration of the time period. In another example, fault injector 632 may prevent second request 628 from being provided to network-based service 602. This advantageously enables timeout scenarios to be tested for first network-based service 602.

At step 504, the fault-injected second response is provided to the first network-based service. For example, with reference to FIG. 6, fault injector 632 provides a fault-injected second response 632 to first network-based service 602.

### III. Example Mobile and Stationary Device Embodiments

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including in FIGS. 1-6, along with any modules, components and/or subcomponents thereof, as well as the flowcharts/flow diagrams described herein, including portions thereof, and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

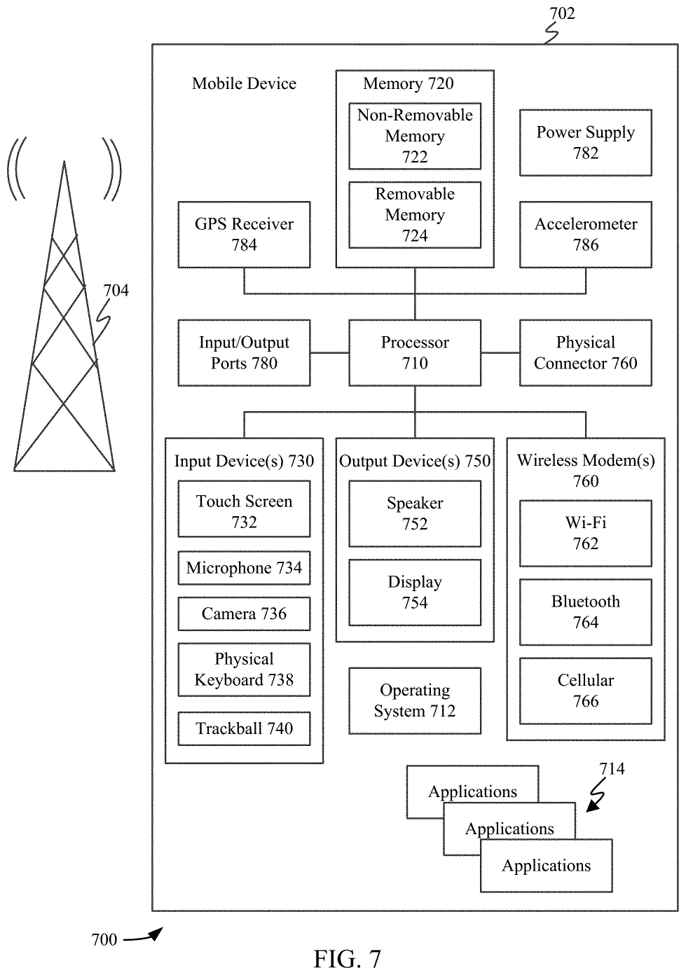

FIG. 7 is a block diagram of an exemplary mobile system 700 that includes a mobile device 702 that may implement embodiments described herein. For example, mobile device 702 may be used to implement any system, client, or device, or components/subcomponents thereof, in the preceding sections. As shown in FIG. 7, mobile device 702 includes a variety of optional hardware and software components. Any component in mobile device 702 can communicate with any other component, although not all connections are shown for ease of illustration. Mobile device 702 can be any of a variety of computing devices (e.g., cell phone, smart phone, handheld computer, Personal Digital Assistant (PDA), etc.) and can allow wireless two-way communications with one or more mobile communications networks 704, such as a cellular or satellite network, or with a local area or wide area network.

Mobile device 702 can include a controller or processor 710 (e.g., signal processor, microprocessor, ASIC, or other control and processing logic circuitry) for performing such tasks as signal coding, data processing, input/output processing, power control, and/or other functions. An operating system 712 can control the allocation and usage of the components of mobile device 702 and provide support for one or more application programs 714 (also referred to as “applications” or “apps”). Application programs 714 may include common mobile computing applications (e.g., e-mail applications, calendars, contact managers, web browsers, messaging applications) and any other computing applications (e.g., word processing applications, mapping applications, media player applications).

Mobile device 702 can include memory 720. Memory 720 can include non-removable memory 722 and/or removable memory 724. Non-removable memory 722 can include RAM, ROM, flash memory, a hard disk, or other well-known memory devices or technologies. Removable memory 724 can include flash memory or a Subscriber Identity Module (SIM) card, which is well known in GSM communication systems, or other well-known memory devices or technologies, such as “smart cards.” Memory 720 can be used for storing data and/or code for running operating system 712 and application programs 714. Example data can include web pages, text, images, sound files, video data, or other data to be sent to and/or received from one or more network servers or other devices via one or more wired or wireless networks. Memory 720 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 720. These programs include operating system 712, one or more application programs 714, and other program modules and program data. Examples of such application programs or program modules may include, for example, computer program logic (e.g., computer program code or instructions) for implementing one or more of first network-based service 102, second network-based service 104, proxy 106, machine learning model 108, first network-based service 302, second network-based service 304, proxy 306, network-based service model 308, mode selector 312, transaction analyzer 314, machine learning algorithm 316, data store analyzer 320, monitor 330, first network-based service 602, second network-based service 604, proxy 606, network-based service model 608, mode selector 612, transaction analyzer 614, machine learning algorithm 616, data store analyzer 620, monitor 630, fault injector 632, along with any components and/or subcomponents thereof, as well as the flowcharts/flow diagrams described herein (e.g., flowchart 200, flowchart 400, and/or flowchart 500), including portions thereof, and/or further examples described herein.

Mobile device 702 can support one or more input devices 730, such as a touch screen 732, a microphone 734, a camera 736, a physical keyboard 738 and/or a trackball 740 and one or more output devices 750, such as a speaker 752 and a display 754. Other possible output devices (not shown) can include piezoelectric or other haptic output devices. Some devices can serve more than one input/output function. For example, touch screen 732 and display 754 can be combined in a single input/output device. Input devices 730 can include a Natural User Interface (NUI).

One or more wireless modems 760 can be coupled to antenna(s) (not shown) and can support two-way communications between processor 710 and external devices, as is well understood in the art. Modem 760 is shown generically and can include a cellular modem 766 for communicating with the mobile communication network 704 and/or other radio-based modems (e.g., Bluetooth 764 and/or Wi-Fi 762). At least one wireless modem 760 is typically configured for communication with one or more cellular networks, such as a GSM network for data and voice communications within a single cellular network, between cellular networks, or between the mobile device and a public switched telephone network (PSTN).

Mobile device 702 can further include at least one input/output port 780, a power supply 782, a satellite navigation system receiver 784, such as a Global Positioning System (GPS) receiver, an accelerometer 786, and/or a physical connector 790, which can be a USB port, IEEE 1394 (FireWire) port, and/or RS-232 port. The illustrated components of mobile device 702 are not required or all-inclusive, as any components can be deleted and other components can be added as would be recognized by one skilled in the art.

In an embodiment, mobile device 702 is configured to implement any of the above-described features of flowcharts herein. Computer program logic for performing any of the operations, steps, and/or functions described herein may be stored in memory 720 and executed by processor 710.

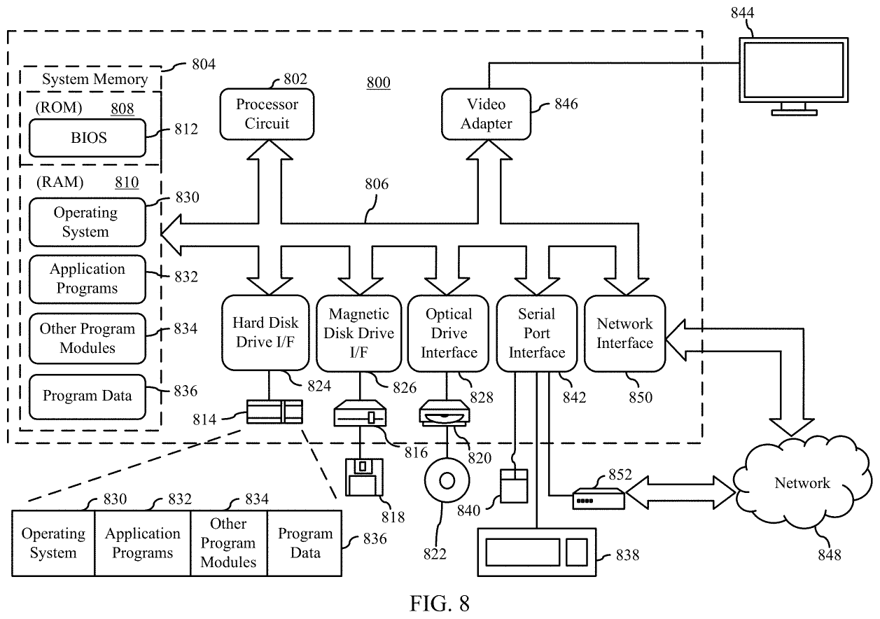

FIG. 8 depicts an exemplary implementation of a computing device 800 in which embodiments may be implemented. For example, embodiments described herein may be implemented in one or more computing devices similar to computing device 800 in stationary or mobile computer embodiments, including one or more features of computing device 800 and/or alternative features. The description of computing device 800 provided herein is provided for purposes of illustration, and is not intended to be limiting. Embodiments may be implemented in further types of computer systems and/or game consoles, etc., as would be known to persons skilled in the relevant art(s).

As shown in FIG. 8, computing device 800 includes one or more processors, referred to as processor circuit 802, a system memory 804, and a bus 806 that couples various system components including system memory 804 to processor circuit 802. Processor circuit 802 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 802 may execute program code stored in a computer readable medium, such as program code of operating system 830, application programs 832, other programs 834, etc. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computing device 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include first network-based service 102, second network-based service 104, proxy 106, machine learning model 108, first network-based service 302, second network-based service 304, proxy 306, network-based service model 308, mode selector 312, transaction analyzer 314, machine learning algorithm 316, data store analyzer 320, monitor 330, first network-based service 602, second network-based service 604, proxy 606, network-based service model 608, mode selector 612, transaction analyzer 614, machine learning algorithm 616, data store analyzer 620, monitor 630, fault injector 632, along with any components and/or subcomponents thereof, as well as the flowcharts/flow diagrams described herein (e.g., flowchart 200, flowchart 400, and/or flowchart 500), including portions thereof, and/or further examples described herein.

A user may enter commands and information into the computing device 800 through input devices such as keyboard 838 and pointing device 840. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 802 through a serial port interface 842 that is coupled to bus 806, but may be connected by other interfaces, such as a parallel port, game port, or a universal serial bus (USB).

A display screen 844 is also connected to bus 806 via an interface, such as a video adapter 846. Display screen 844 may be external to, or incorporated in computing device 800. Display screen 844 may display information, as well as being a user interface for receiving user commands and/or other information (e.g., by touch, finger gestures, virtual keyboard, etc.). In addition to display screen 844, computing device 800 may include other peripheral output devices (not shown) such as speakers and printers.

Computing device 800 is connected to a network 848 (e.g., the Internet) through an adaptor or network interface 850, a modem 852, or other means for establishing communications over the network. Modem 852, which may be internal or external, may be connected to bus 806 via serial port interface 842, as shown in FIG. 8, or may be connected to bus 806 using another interface type, including a parallel interface.

As used herein, the terms “computer program medium,” “computer-readable medium,” and “computer-readable storage medium,” etc., are used to refer to physical hardware media. Examples of such physical hardware media include the hard disk associated with hard disk drive 814, removable magnetic disk 818, removable optical disk 822, other physical hardware media such as RAMs, ROMs, flash memory cards, digital video disks, zip disks, MEMs, nanotechnology-based storage devices, and further types of physical/tangible hardware storage media (including memory 820 of FIG. 8). Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 832 and other programs 834) may be stored on the hard disk, magnetic disk, optical disk, ROM, RAM, or other hardware storage medium. Such computer programs may also be received via network interface 850, serial port interface 842, or any other interface type. Such computer programs, when executed or loaded by an application, enable computing device 800 to implement features of embodiments discussed herein. Accordingly, such computer programs represent controllers of the computing device 800.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### IV. Additional Exemplary Embodiments

A system is described herein. The system includes: at least one processor circuit; at least one memory that stores program code configured to be executed by the at least one processor circuit, the program code comprising: a proxy configured to: in a first mode: receive a set of first requests from a first network-based service communicatively coupled to the proxy, provide the set of first requests to a second network-based service communicatively coupled to the proxy, receive a set of first responses from the second network-based service, provide the set of first responses to the first network-based service, and provide training data corresponding to the set of first requests and the set of first responses to a machine learning algorithm, the machine learning algorithm configured to generate a network-based service model based on the training data, the network-based service model configured to simulate a behavior of the second network-based service; and in a second mode: receive a second request from the first network-based service, provide the second request to the network-based service model, and provide a second response generated by the network-based service model to the first network-based service.

In an embodiment, the machine learning algorithm is a deep neural network-based machine learning algorithm.

In an embodiment, the proxy is further configured to: inject a fault in the second response generated by the network-based service model; and provide the fault-injected second response to the first network-based service.

In an embodiment, the proxy is configured to inject the fault by performing at least one of: modifying a sequence number specified by the second request; modifying a timestamp specified by the second request; modifying a status code of the second request; or injecting a delay at which the second request is provided to the first network-based service.

In an embodiment, each of the first network-based service and the second network-based service comprises at least one of: a web service; a web application programming interface; or a microservice.

In an embodiment, the proxy is further configured to: determine that the network-based service model is generated; and in response to a determination that the network-based service model is generated, activate the second mode.

In an embodiment, the proxy is further configured to: provide second training data, corresponding to transactions performed by the second network-based service with respect to a data store communicatively coupled to the second network-based service, to the machine learning algorithm.

A method performed by a proxy communicatively coupled to a first network-based service and a second network-based service for validating the first network-based service is also described herein. The method includes: in a first mode: receiving a set of first requests from the first network-based service, providing the set of first requests to the second network-based service, receiving a set of first responses from the second network-based service, providing the set of first responses to the first network-based service, and providing training data corresponding to the set of first requests and the set of first responses to a machine learning algorithm, the machine learning algorithm configured to generate a network-based service model based on the training data, the network-based service model configured to simulate a behavior of the second network-based service; and in a second mode: receiving a second request from the first network-based service, providing the second request to the network-based service model, and providing a second response generated by the network-based service model to the first network-based service.

In an embodiment, the machine learning algorithm is a deep neural network-based machine learning algorithm.

In an embodiment, said providing the second response generated by the network-based service model to the first network-based service comprises: injecting a fault in the second response generated by the network-based service model; and providing the fault-injected second response to the first network-based service.

In an embodiment, said injecting the fault in the second response comprises at least one of: modifying a sequence number specified by the second request; modifying a timestamp specified by the second request; modifying a status code of the second request; or injecting a delay at which the second request is provided to the first network-based service.

In an embodiment, each of the first network-based service and the second network-based service comprises at least one of: a web service; a web application programming interface; or a microservice.

In an embodiment, the method further comprises: determining that the network-based service model is generated; and in response to determining that the network-based service model is generated, activating the second mode.

In an embodiment, the method further comprises: providing second training data, corresponding to transactions performed by the second network-based service with respect to a data store communicatively coupled to the second network-based service, to the machine learning algorithm.

A computer-readable storage medium having program instructions recorded thereon that, when executed by a processor of a computing device, perform a method implemented by a proxy communicatively coupled to a first network-based service and a second network-based service for validating the first network-based service. The method includes: in a first mode: receiving a set of first requests from the first network-based service, providing the set of first requests to the second network-based service, receiving a set of first responses from the second network-based service, providing the set of first responses to the first network-based service, and providing training data corresponding to the set of first requests and the set of first responses to a machine learning algorithm, the machine learning algorithm configured to generate a network-based service model based on the training data, the network-based service model configured to simulate a behavior of the second network-based service; and in a second mode: receiving a second request from the first network-based service, providing the second request to the network-based service model, and providing a second response generated by the network-based service model to the first network-based service.

In an embodiment, the machine learning algorithm is a deep neural network-based machine learning algorithm.

In an embodiment, said providing the second response generated by the network-based service model to the first network-based service comprises: injecting a fault in the second response generated by the network-based service model; and providing the fault-injected second response to the first network-based service.

In an embodiment, said injecting the fault in the second response comprises at least one of: modifying a sequence number specified by the second request; modifying a timestamp specified by the second request; modifying a status code of the second request; or injecting a delay at which the second request is provided to the first network-based service.

In an embodiment, each of the first network-based service and the second network-based service comprises at least one of: a web service; a web application programming interface; or a microservice.

In an embodiment, the method further comprises: determining that the network-based service model is generated; and in response to determining that the network-based service model is generated, activating the second mode.

In an embodiment, the network-based service model is transferable to and executable on a plurality of computing devices.

### V. CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A system, comprising:
at least one processor circuit;
at least one memory that stores program code configured to be executed by the at least one processor circuit, the program code comprising:
a proxy configured to:
in a first mode:
receive a set of first requests from a first network-based service communicatively coupled to the proxy,
provide the set of first requests to a second network-based service communicatively coupled to the proxy,
receive a set of first responses from the second network-based service,
provide the set of first responses to the first network-based service, and
provide training data corresponding to the set of first requests and the set of first responses to a machine learning algorithm, the machine learning algorithm configured to generate a network-based service model based on the training data, the network-based service model configured to simulate a behavior of the second network-based service; and
in a second mode:
receive a second request from the first network-based service,
provide the second request to the network-based service model, and
provide a second response generated by the network-based service model to the first network-based service.

2. The system of claim 1, wherein the machine learning algorithm is a deep neural network-based machine learning algorithm.

3. The system of claim 1, wherein the proxy is further configured to:
inject a fault in the second response generated by the network-based service model; and
provide the fault-injected second response to the first network-based service.

4. The system of claim 3, wherein the proxy is configured to inject the fault by performing at least one of:
modifying a sequence number specified by the second request;
modifying a timestamp specified by the second request;
modifying a status code of the second request; or
injecting a delay at which the second request is provided to the first network-based service.

5. The system of claim 1, wherein each of the first network-based service and the second network-based service comprises at least one of:
a web service;
a web application programming interface; or
a microservice.

6. The system of claim 1, wherein the proxy is further configured to:
determine that the network-based service model is generated; and
in response to a determination that the network-based service model is generated, activate the second mode.

7. The system of claim 1, wherein the proxy is further configured to:
provide second training data, corresponding to transactions performed by the second network-based service with respect to a data store communicatively coupled to the second network-based service, to the machine learning algorithm.

8. A method performed by a proxy communicatively coupled to a first network-based service and a second network-based service for validating the first network-based service, comprising:
in a first mode:
receiving a set of first requests from the first network-based service,
providing the set of first requests to the second network-based service,
receiving a set of first responses from the second network-based service,
providing the set of first responses to the first network-based service, and
providing training data corresponding to the set of first requests and the set of first responses to a machine learning algorithm, the machine learning algorithm configured to generate a network-based service model based on the training data, the network-based service model configured to simulate a behavior of the second network-based service; and
in a second mode:
receiving a second request from the first network-based service,
providing the second request to the network-based service model, and
providing a second response generated by the network-based service model to the first network-based service.

9. The method of claim 8, wherein the machine learning algorithm is a deep neural network-based machine learning algorithm.

10. The method of claim 8, wherein said providing the second response generated by the network-based service model to the first network-based service comprises:
injecting a fault in the second response generated by the network-based service model; and
providing the fault-injected second response to the first network-based service.

11. The method of claim 10, wherein said injecting the fault in the second response comprises at least one of:
modifying a sequence number specified by the second request;
modifying a timestamp specified by the second request;
modifying a status code of the second request; or
injecting a delay at which the second request is provided to the first network-based service.

12. The method of claim 8, wherein each of the first network-based service and the second network-based service comprises at least one of:
a web service;
a web application programming interface; or
a microservice.

13. The method of claim 8, further comprising:
determining that the network-based service model is generated; and
in response to determining that the network-based service model is generated, activating the second mode.

14. The method of claim 8, further comprising:
providing second training data, corresponding to transactions performed by the second network-based service with respect to a data store communicatively coupled to the second network-based service, to the machine learning algorithm.

15. A computer-readable storage medium having program instructions recorded thereon that, when executed by a processor of a computing device, perform a method implemented by a proxy communicatively coupled to a first network-based service and a second network-based service for validating the first network-based service, the method comprising:
in a first mode:
receiving a set of first requests from the first network-based service,
providing the set of first requests to the second network-based service,
receiving a set of first responses from the second network-based service,
providing the set of first responses to the first network-based service, and
providing training data corresponding to the set of first requests and the set of first responses to a machine learning algorithm, the machine learning algorithm configured to generate a network-based service model based on the training data, the network-based service model configured to simulate a behavior of the second network-based service; and
in a second mode:
receiving a second request from the first network-based service,
providing the second request to the network-based service model, and
providing a second response generated by the network-based service model to the first network-based service.

16. The computer-readable storage medium of claim 15, wherein the machine learning algorithm is a deep neural network-based machine learning algorithm.

17. The computer-readable storage medium of claim 15, wherein said providing the second response generated by the network-based service model to the first network-based service comprises:
injecting a fault in the second response generated by the network-based service model; and
providing the fault-injected second response to the first network-based service.

18. The computer-readable storage medium of claim 17, wherein said injecting the fault in the second response comprises at least one of:
modifying a sequence number specified by the second request;
modifying a timestamp specified by the second request;
modifying a status code of the second request; or
injecting a delay at which the second request is provided to the first network-based service.

19. The computer-readable storage medium of claim 15, wherein each of the first network-based service and the second network-based service comprises at least one of:
a web service;
a web application programming interface; or
a microservice.

20. The computer-readable storage medium of claim 15, the network-based service model is transferable to and executable on a plurality of computing devices.
